(19) United States
(12) Patent Application Publication
(10) Pub. No.: US 2026/0266462 A1
(43) Pub. Date: Sep. 10, 2026

(54) Solar Powered Cigarette Lighter

(71) Applicant: Bedlu Hailemichael, Houston, TX (US)

(72) Inventor: Bedlu Hailemichael, Houston, TX (US)

(21) Appl. No.: 19/070,029

(22) Filed: Mar. 4, 2025

(51) Int. Cl. F23Q 7/18; F23Q 7/16; H02S 20/30

(52) U.S. Cl. CPC F23Q 7/18; F23Q 7/16; H02S 20/30

(57) ABSTRACT

The invention comprises of solar cell(panel), along with a rechargeable lithium-ion battery, electronic circuit which is connected with the battery and the glow coil, so that, it can be recharged with a DC, or AC, household outlet.

And the main purpose of the invention is intended to lit up cigarettes for smokers, with it's glow coil.

Solae power cells can generate electricity, the idea had been known for almost a century. However, the application of Solar power cells had not been developed until very recent years.

Meanwhile, the application of solar electric cell has become well introduced since 1954, and people in this field have brought a lot of improvements and progress for mankind.

At the present solar electric cells have become very popular and advanced. Therefore,

This endless energy source(the sun) , can surely aid in reducing our reliance of fossil fuels. In my small-scale research, I have come up with the idea of solar powered cigarette lighter's which can eliminate the use of flammable gaseous that are hazardous to the environment.

My type of lighter is constructed with a 2 by 2 square inches solar panel(cell), that have a Five, volt battery generating power source at the onset and 1.060, Amps of electrical power supply source. A wire, which glow when the lighter is activated, will be attached on the top right, hand part of the solar powered lighter. An attached on/off switch will both activate and deactivate this lighter on command. The main purpose of the solar cell (panel) , is to recharge the lithium-ion battery which is encapsulated with the rechargeable 5.0, volts and 1.060 Amps. In order to charge the battery, at the time of depletion, the user will be placing the solar-lighter where available light sources are present. This will again recharge the lithium-ion battery, thence, the lighter will again function normally.

This application is very ideal for countries that get a lot of sunshine year-round, such as, but not limited to, the Middle East, Africa, Asia, South America and the U.S.A. sun belt states.

Furthermore, this solar powered cigarette lighter can be recharged in many ways. One of the main power-source which would enabling to recharge the battery from the outer surface of the solar panel(cell), will be household light bulbs and Fluorescent light lamps. In addition to this, the solar powered cigarette lighter can be recharged from a household AC, out late and DC, power source with an inverter.

Above all users/consumers could also use automobile cigarette out late while they are driving. Moreover, campers and hikers also could be benefited from this lighter.

At this point of time, people can use this alternate means of lighter without a loss of power source during night or winter seasons.

The benefit of this lighter will providing a wide range of consumer needs with a minimum amount of cost compared with other leading non eco friendly similar products. Henceforth, the solar powered cigarette lighter outweighs the advantage of performance and life cycle compared to full operated cigarette lighter those are currently on the market.

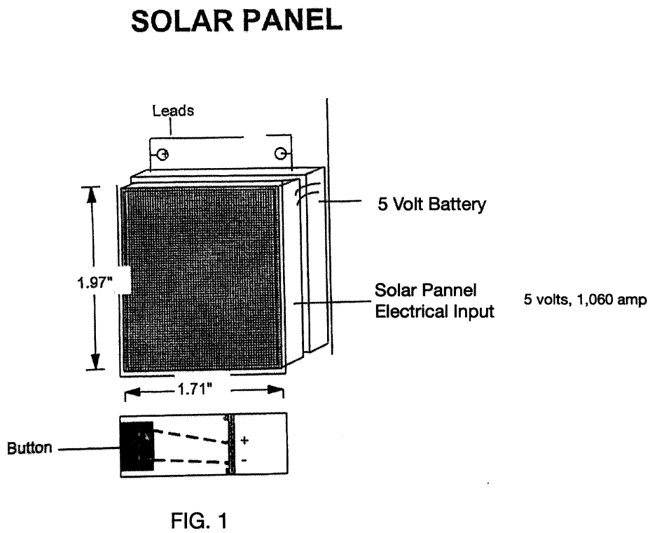

FIG. 1. Shows,

The solar panel and it's contents, battery holder space with its output, leads or Anode And the Cathode, the element with the activation button.

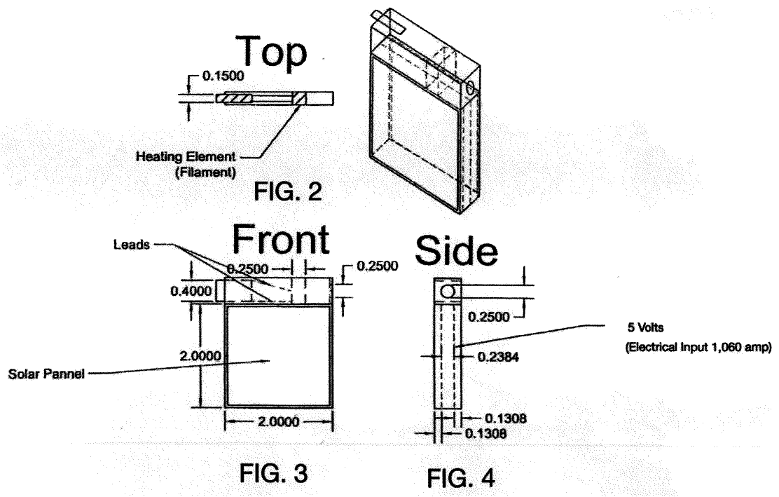

FIG. 2. Element (Filament), The glow coil that makes the cigarettes to be lit up.

FIG. 3. The Leads, the, height and width of it.

The solar panel, the width and heights of the panel. Battery compartment or battery holder space.

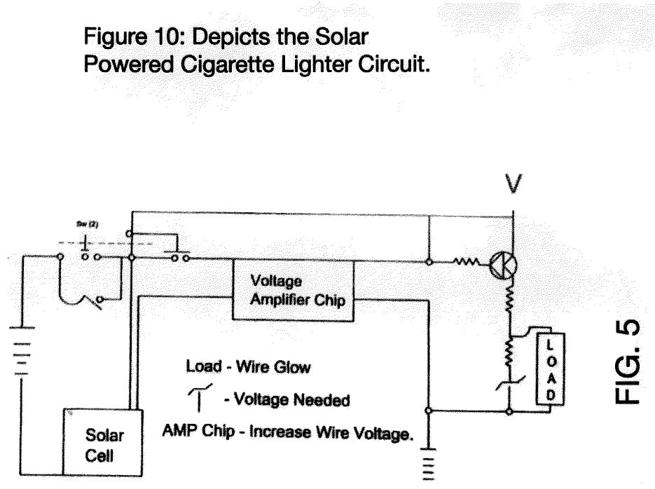

FIG. 4. The side view that shows, where the cigarettes enter. Battery compartment or battery holder, the cigarette size and the width of the battery compartment space.

FIG. 5. Shows, Load, filament, voltage amplifier, switch, Amp chip-increase the voltage needed for the coil. Solar cell, Diode, Battery.

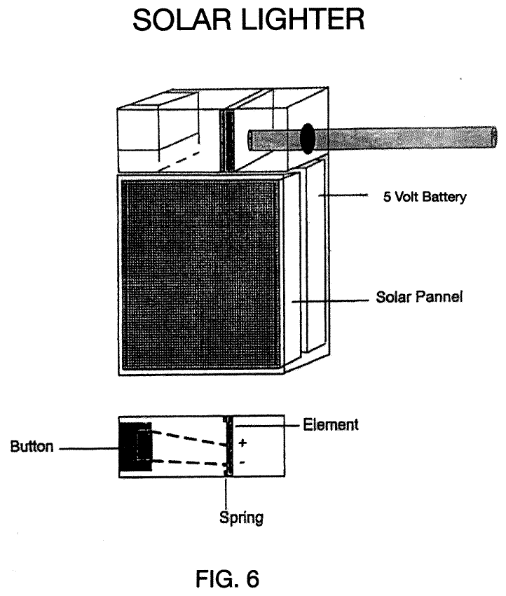

FIG. 6. Solar Lighter, cigarette inside the element space, solar panel, Element positive and negative terminals, spring, button which will be used to activate and deactivate the power source.

1) The main components of the said invention of solar powered cigarette lighter is: The glow coil, electronic circuit that is taking power from outer power sources, such as, DC, and AC, household outlets.

2) The solar powered cigarette lighter along with electronic circuit and solar cell as well as the lithium-ion battery connected with the two Anode and Cathode, rod's which would initiate to lit up cigarette with a glow coil.
